(19) United States
(12) Patent Application Publication
(10) Pub. No.: US 2015/0108840 A1
(43) Pub. Date: Apr. 23, 2015

(54) REMOTE ISOLATION SYSTEM, METHOD AND APPARATUS

(71) Applicant: ICM Technologies Pty Ltd, Canning Vale DC (AU)

(72) Inventors: Michael Lane, Dianella (AU); Jack Mross, Fremantle (AU); Julian Hughes, Aveley (AU); Phil Rohrlach, Ardross (AU)

(73) Assignee: ICM Technologies Pty Ltd, Canning Vale DC (AU)

(21) Appl. No.: 14/060,729

(22) Filed: Oct. 23, 2013

(51) Int. Cl. G05B 9/02

(52) U.S. Cl. CPC G05B 9/02
USPC 307/31

(57) ABSTRACT

A remote isolation system for a plant using a plurality of plant equipment items and a plant control system in communication with these equipment items. The plant control system enables isolation, from an energy source, of the plant equipment items. The plant control system includes selecting means for selecting a set of equipment items to be isolated; and control means to command isolation of the selected set of plant equipment items following approval by the plant control system. The remote isolation system offers advantages in safety, time and cost effective isolation which facilitates plant shutdowns for maintenance or other purposes

### FIELD OF THE INVENTION

The present invention relates to a remote isolation system, method and apparatus for isolating equipment in order to safely perform maintenance or other work on such equipment or ancillary components of the equipment.

Various types of equipment must be isolated from a range of energy sources including electrical energy (the most common) and mechanical energy including pressure and potential, to enable safe maintenance and other work. For example, conveyor belt systems used in the mining industry, for example in the North West of Western Australia, for transporting iron ore or other bulk materials, can span significant distances. These distances can be in the range of many kilometers. These conveyors are typically powered by electrical motors (3 phase electrical power is supplied and the voltage may range from low voltage, from below 600 V to 1000 V AC, to medium and high voltage in the multiple kV range and extending to above 10 kVAC and even 33 kVAC) and use brake systems which are also electrically operated (and may be designed to fail, or be de-energised, in the brake-on mode).

Unplanned downtime of such conveyor system is costly in terms of lost production and revenue. In order to undertake remedial mechanical works on a conveyor such as tramp metal removal, idler replacement and rip detector restring, the system must be rendered safe for such work to be carried out.

Although different mine procedures and relevant safety standards may apply, a typical pre-requisite before permitting mechanical maintenance or other activity involving access to the conveyor belt system involves the electrical isolation of the conveyor system. This isolation ensures that the energy source powering the conveyor belts and associated equipment (ie electrical power) is removed from all system components that could result in conveyor belt movement. In such situations, all belt drive motors and brakes are electrically isolated.

Isolation is not achieved by actuation of emergency stopping devices such as emergency stop buttons, lanyards, rope switches and similar quick stop devices. Such devices are not designed for frequent use and cannot be locked out in all cases. In addition, emergency stopping devices may still allow energy—typically in mechanical form such as release of conveyor belt tension—to be released. Inadvertent reactivation and continued operation of control circuits are additional risks.

Because of the potentially serious consequences of conveyor belt movement whilst work is being conducted on the belt or its ancillary components, electrical isolation procedures are often very structured and require multiple levels of approvals and human interactions. For example, when a tramp metal detector triggers a belt stoppage, a known isolation procedure proceeds as follows:
1. A tramp metal detection (“TMD”) fault signal is issued to the plant control system, for example a DCS (Distributed Control System), automatically initiates a stop on the relevant conveyor belt by opening circuit interrupters, in the form of a set of circuit breakers and/or contactors dependent on the relevant voltage (low, medium or high) for operation of the equipment, to remove power to the relevant belt drive and brakes etc. The DCS is fully integrated to ensure that a proper belt stop procedure is followed having regard to any upstream or downstream processes that might be affected by such belt stop;
2. The Control Room Operator (CRO) is informed of the fault and requests authorised personnel to check the system and remove the fault. This step may alternatively involve personnel that are located close to the tramp metal detection station itself contacting via phone, or other communication means, the CRO and requesting isolation of the belt to allow works such as maintenance to be performed.
3. Before any activity can be performed on the conveyor belt, a duly authorised Isolation Officer must electrically isolate it against unexpected start. The isolation is effected by operating circuit interrupter(s), such as a set of circuit interrupters, which are in series with the first circuit interrupter(s) described in item 1 above. This typically takes time as the authorised Isolation Officer may need to travel (in some cases, many kilometers) to the relevant electrical sub-station to perform the isolation, may be attending to other faults in the plant, may be carrying out other duties at the time, or are on a relief break.
4. As there is some danger of arc flash when operating the isolation mechanism to disconnect the circuit interrupter(s), for example a set of circuit breakers in the relevant electrical sub-station, the Isolation Officer must wear an arc flash suit during disconnection. Disconnection is therefore an undesirable and dangerous task which again adds time delay to the overall process. Nominally, the electrical power to the conveyor belt has already been removed so that there should be no arcing or danger involved—however history shows that arcing can happen due to equipment failure or inconsistent switching action.
   In some cases, even though the belt system has stopped, one or two of the three circuit interrupter/contactor contacts (corresponding with the 3 phase power source) under the control of the CRO may have welded so as to leave power to one or two of the three lines respectively (such power not necessarily being sufficient to maintain movement of the belt at that time). Breaking of the sub-station circuit interrupters, such as circuit breakers, by an Isolation Officer could in this case lead to dangerous arcing.
5. Once the Isolation Officer has operated the isolation mechanism (for example racking down and out of the second circuit interrupter(s) or circuit breakers) the electrical isolation may be visually confirmed. That is, in racked down and out position, it can clearly be seen that no electrical contact is in place between electrical contacts and the electrical supply or “load” line.
6. The CRO or Isolation Officer then performs what is commonly known as a “Try Start” wherein a request is made of the control system to start in accordance with the normal starting procedure. Only when it is confirmed that the belt system does not start (via suitable system feedback sensor that may measure conveyor belt movement or motor pulley rotation) does the CRO inform the relevant personnel that isolation has been implemented.
7. The relevant personnel attending the relevant sub-station then place one or more personal padlocks or other device on the isolation mechanism to prevent accidental re-engagement. In the present example, mine regulations and practice demand that no person other than the padlock owner(s), in this case the relevant personnel, are permitted to remove their personal padlock(s). Once so padlocked, the Isolation Officer informs the CRO that isolation is complete and works or maintenance may begin. As this may take some time, the Isolation Officer may leave the sub-station and attend to other duties.
8. Upon completing the works, the personnel inform the CRO. The CRO then requests the Isolation Officer to return to the sub-station to de-isolate the system. The maintenance personnel must also attend the sub-station to remove the personal padlocks. This results in additional time delay as noted in steps 4 and 5 above. The Isolation Officer then proceeds to de-isolate the system by re-engaging the first and second circuit interrupters. In order to prevent an uncontrolled start, typically, a feedback from the primary circuit interrupter(s) will not permit a start or run signal to be active.
9. On completing the de-isolation procedure, the Isolation Officer informs the CRO. A controlled restart of the system is then performed by the plant control system.

The above isolation method, whilst providing high safety assurance, can result in significant delays—up to and even in excess of several hours—in performing unscheduled works and maintenance typically resulting in significant costs in lost productivity and revenue, as well as exposure to safety risks in the relevant sub-station for the equipment.

To address these issues, the Applicant has disclosed a remote isolation system for isolating an energy source from selected equipment energizable by the energy source and controlled by a control system. The control system includes a remote isolation station for the selected equipment to be isolated. This remote isolation station is communicable with the control system which grants isolation approval on permissible request. The remote isolation station has a human machine interface (HMI) for requesting an isolation of the control system, a human interpretable display for indicating that an isolation approval has been granted from the control system, and an isolation switch for communicating to the control system that an isolation is in effect.

### SUMMARY OF THE INVENTION

It is useful to secure isolation, both when equipment items have malfunctioned and at other times, for example during scheduled maintenance. Even if a remote isolation system, as previously disclosed by the Applicant is used, considerable time may still be spent isolating a potentially large number of equipment items when preparing for scheduled maintenance.

It is therefore an object of the invention to provide a remote isolation system suitable for isolating equipment items or equipment systems in a time efficient manner in preparation for scheduled maintenance or plant shutdowns for other reasons. Such shutdown may involve the whole or any part of a plant.

With this object in view, the present invention provides a remote isolation system for a plant comprising
a plurality of equipment items; and
a control system being in communication with said plurality of equipment items for enabling isolation of said equipment items from an energy source:

wherein said control system includes selecting means for selecting a set of equipment items to be isolated and means to command isolation of a selected set of equipment items, to isolate said equipment items in said selected set following approval by the control system.

The control system—and typically a computer processor unit (CPU) of the control system—may include, or may generate, one or more configurable or virtual isolation station(s) (“CIS”) for isolating said selected set of equipment items. The configurable isolation station(s) will control hardware and software required to perform isolation. The configurable isolation stations may be located remotely from the selected set of equipment items though in communication with that set. The isolation module may isolate the selected set of equipment items independently of operation of any physical remote or field isolation station(s) correspondent with equipment items within the selected set of equipment items. The configurable isolation may correspond with one or a plurality of equipment items, identifiers for which may be stored in a database forming part of the control system.

The remote isolation system may include one or more remote isolation stations correspondent with selected equipment items, these stations advantageously being controlled by the plant control, system, either the centralized plant control system. such as a SCADA, or through a distributed control system (DCS) in which each remote isolation system is provided with its own dedicated processor (computer control unit) to maximise system safety rating, ideally as measured by SIL 3 or above of the SIL scale. However, provision of dedicated remote isolation stations for each selected equipment item for isolation is not essential and may be impractical in some instances. For example, the nature of the equipment or its location may make provision of remote or field isolation stations correspondent with equipment items impractical.

The selecting means may take a number of forms depending on the reason for requiring a set of equipment items to be isolated. The set may include one equipment item or a plurality of equipment items. The set could include all equipment items in a plant, this being a useful feature where a shutdown is required whether for maintenance or other reasons. The equipment items may therefore be comprised in one or more sub-systems of a plant, particularly in partial or total shutdown situations. This would be useful for maintenance type shutdowns involving certain plant sub-system(s) which would typically correspond with particular processes being conducted in the plant, for example material handling in the case of conveyor systems; and motors driving pumps, agitators or other equipment in the case of physical or chemical processes, a range of which can be envisaged. A human machine interface (HMI) may be included in the control system, as at least part of a selection means, to enable plant personnel to select a set of equipment items to be isolated. This interface could be a computer, such as a personal computer, including a graphic user interface which, for example, allows the personnel to select sets of equipment items by visually identifying equipment items or plant sub-system(s) on a mimic of the plant flowsheet and taking a step, for example pressing on a button (conveniently on a touch screen though such a graphic user interface is not essential and may be avoided, being substituted by another less fragile form of button or switch to avoid likely damage during service), to isolate the selected set of equipment items. Any device that allows operator selection of a set of equipment items to be isolated is suitable for use within the isolation system.

One way to select the CIS isolation stations is through a “drag and drop” procedure. familiar to computer users. In such case, a list of plant equipment item identifiers, as stored in a database could appear in a window on the graphic user interface. For example, where the plant includes multiple conveyor belt systems (each including a number of conveyor belt system components), desired conveyor belt systems may be highlighted from this list and dropped into a list of equipment items to be isolated during the maintenance works, this list being stored as an input to the control system during implementation of isolation and later de-isolation. The plant control system, through a master controller, may check, at this time, that the selection of equipment items for isolation is correct.

The equipment item database may be updated from time to time dependent on new equipment items being commissioned and other equipment items being decommissioned.

On completion of the equipment item selection process, isolation steps may be implemented for each set of equipment items, or processes, selected for isolation.

While the human machine interface is conveniently located in a central control room (CCR) for a given plant, this is not essential. The interface may be located at any convenient site. However, the CCR is a convenient location. Whatever location is selected is designated a “permit room” where steps required for isolation are verified. Verification may include the steps of patrolling remote isolation stations correspondent with selected equipment items and checking that keys for isolation switches at the remote isolation stations have been returned prior to any works being performed on the isolated equipment items.

When a set of equipment items is selected for isolation, the plant control system still performs approval and checking steps to ensure that isolation for the selected set of equipment items is consistent with a current set of permissives. For example, the set may be compared with a maintenance schedule or known maintenance history or operating state of the equipment items. If there is inconsistency between selection of equipment items for isolation and need for isolation, then the selected equipment items may be deleted from a list of equipment items for isolation. This approval step also allows for error correction. If the incorrect, or incomplete, list of equipment items have been selected for isolation, the error can be corrected prior to isolation and potentially very significant costs of unnecessary and/or unsafe shutdowns avoided.

Each remote isolation station, where used, may conveniently be in communication with the control system for granting isolation of its corresponding equipment item from an energy source on permissible request. To this end, each remote isolation station may have a human machine interface—whether provided in the form of a graphical user interface, buttons, switches or any other form of interface device—for requesting an isolation of the selected equipment item, a human interpretable display for indicating that an isolation approval has been granted from the control system, and an isolation switch means for communicating to the control system that an isolation is in effect. The control system therefore allows supervision of an operator initiated isolation request without need, under permissible circumstances, for an Isolation Officer to undertake time consuming and sometimes hazardous isolation as done previously.

The remote isolation station is advantageously located proximate to the selected equipment to be isolated. By allowing maintenance and other authorised personnel to request and implement an isolation of the selected equipment at a location proximate to where the work is intended to be carded out (as opposed to having to travel to a relevant sub-station as per existing requirements), significant time and cost savings can be made. Alternatively, the remote isolation station may be located at a distance, even a significant distance, from the equipment to be isolated.

The remote isolation system includes first circuit interrupter(s), such as one or more isolation contacts, which are in series connection with a primary stop/start switch for the selected equipment, said first circuit interrupter(s) being controlled to the off state once isolation approval has been granted. This provides a first point of isolation. One or more sets of first circuit interrupters, providing still further safety, may be included for this purpose.

Alliteratively, or in addition to the first circuit interrupter(s), the remote isolation system should advantageously include second circuit interrupter(s), for example in the form of circuit breaker(s) or other contactor(s), in an energy supply line from the energy source to the selected equipment, said second circuit interrupter(s) being under the control of the control system and being placed in the off state (ie the break position) once isolation approval has been granted. This provides a second point of isolation in the system being isolation of the energy supply line.

The isolation system may be used for isolation of low, medium and high voltage energised equipment, the definition of low, medium and high voltage being as above described. For low voltage applications, say below 1000 VAC. contactor(s) may be used as the second circuit interrupter(s). For medium and high voltage applications, above about 1000 VAC, operation of the second circuit interrupter(s), likely to be circuit breaker(s), may involve racking out, that is driving out of contact, to break the energy supply line. Such racking out, controlled during operation of the isolation system, also provides a visual indication of isolation. Sensor(s) may be used to confirm such racking out and locking pins should be used to lock the truck carrying electrical contacts in racked out position.

Preferably, when the energy source is electricity, the system further comprises a voltage monitoring means, such as a relay, to sense and monitor voltage downstream of the first circuit interrupters. On isolation, sensed voltage should be at zero volts. The voltage monitoring means should be safety rated to minimise risk of continued energization of the equipment. To this end. the voltage monitoring means should also sense each phase of any electrical supply to the equipment. Analogues to voltage monitoring means for energy sources may be envisaged, for example pressure or flow sensors in the case of steam or working fluid as an energy source.

Preferably, the remote isolation system is configured such that upon the first and second circuit interrupters being placed in the off (or break) state, the control system cannot return these circuit interrupters to the on (or “make”) state unless a predetermined permissive signal is received from the remote isolation station.

The energy source for the selected equipment may provide energy in various forms such as electrical, mechanical such as pressurised air, or mechanical and heat such as steam, or any combination of these. Therefore, the use of electrical terms in this specification, unless the context absolutely requires, is not to be taken to limit the invention to an electrical energy source. The purpose of the invention is to allow the energy supply to the equipment, in whichever form this supply happens to take, to be isolated from the equipment and therefore render the equipment in-operable for the purposes of safety during maintenance. For simplicity. the remaining discussions will reference an electrically powered conveyor belt system recognising however that the equipment need not be limited to a conveyor belt system and the power source need not be limited to electrical power.

Once the remote operator has made a request via the human machine interface of the remote isolation station, typically a Control Room Operator (CRO) will either approve or deny such request (this step may be further automated by allowing a central control system itself to approve or deny the request based on a set of permissives (i.e. pre-conditions that must be met for approval to be granted).

A range of permissives are possible, these being determined on a plant specific basis during design work for the isolation system. Examples of permissives include checking whether the isolation request relates to the correct equipment to be isolated, the state of other plant control indicator(s) and operator skill level. An operator, including the CRO, may be interrogated by the computer processor unit (CPU) of the control system—as to the permissives though some permissives may be checked automatically by the CPU. In some cases, the remote isolation system may permit, either before or after an operator request, isolation on the basis of the skill level of the operator requesting the isolation. Other basis for prospectively permitting isolation may be implemented.

If approved, the remote operator is informed of such approval for isolation to proceed by a suitable indicator at the remote isolation station. Additionally, the control system may also flag this approval at other sites including other remote isolation stations and the CCR. The remote operator is then able to secure the isolation by activating the isolation switch to confirm the isolation. A time-out may apply and the authorization may lapse after such time-out has expired.

Preferably, the isolation switch comprises a locking means for locking the switch in the isolation position with the selected equipment at least isolated from the energy source. The locking means may take the form of a hasp or other mechanically or electrically operable locking device to be personally locked, for example by key or padlock, by the operator requesting isolation, and other operators if required. The locking means prevents the isolation switch from moving out of the isolation position. The locking means may comprise a plate. flap or other restrictor which partially or wholly covers the isolation switch to prevent movement out of the isolation position. Such locking means may be held captive until isolation protocol is completed, then being enabled—when the system identifies correct protocol has been followed—to complete the required isolation through application of operator padlock(s).

The locking means may be in the form of a manual lock out system, which will only allow the remote operator to lock the isolation switch when the approval for isolation is granted. Automatic lock out may be envisaged as well. The isolation system may prevent locking until required isolation procedure, as described above, has been followed. An interlock means such as a solenoid, operable to prevent the isolation switch from being activated (i.e. moved into the isolation position) absent isolation approval may be included. Locking of the isolation switch may also be prevented until the isolation procedure including a “try start” step—as described below—has been completed.

The isolation cannot be removed unless the lock is physically removed and the isolation switch is manually operated. Further, the isolation system may comprise one or more sensors at the remote isolation station to detect that a personal lock has been secured.

In case the interlock means is determined to be faulty, the remote isolation panel can be faulted to render it inoperable and a fault signal provided to the control system to attract maintenance attention.

Other features of a desirable remote isolation switch and interlock means are described in the Applicant's International Patent Publication No. WO 2011/047428, the contents of which are hereby incorporated herein by reference.

Alternatively, or in addition, circuit interrupters, such as circuit breakers, in the energy supply line to the equipment to be isolated may be operated by the plant control system to isolate the equipment.

Preferably, wherever circuit interrupter(s) in the energy supply line to the selected equipment, are operated to off or break state, authority for closing such circuit interrupter(s) is passed under the direct and exclusive control of the remote isolation station.

Preferably, the remote isolation station comprises a human machine interface—whether provided in the form of a graphical user interface, buttons, switches or any other form of interface device—for requesting a “try start”, wherein upon manual activation of the interface, by the operator, a communication signal representative of the ‘try start’ request is sent to the control system. Such a “try start” is consistent with requirements under safety guidelines issued by a number of work safety authorities in Australia and elsewhere.

In effect, a “try start” provides a signal equivalent to a plant control system start signal, to add further assurance that isolation authority rests with the remote isolation station. A “fail to start” signal received from the control system will confirm that the “try start” test has been passed. A “fail to start” signal may be generated if the control system confirms that no belt movements were detected and/or that no voltage (or analogous measure of motive force) appeared on the energy supply lines to the selected equipment.

The remote isolation system may enable an automated or virtual try start, instead of an operator initiated try start, once the selected equipment item is isolated. If the try start is passed, isolation may be implemented by the steps of manual activation of the interface by an operator as a preliminary to locking out of the isolation switch. A manual “try start” may also be requested by an operator following the virtual try start, preferably as the final step before a user observable indication is given that the isolation has been effected.

Other features of a desirable configuration of remote isolation station and the remote panel that may be comprised within it are described in the Applicant's International Patent Publication No. WO20111047428, the contents of which are incorporated herein by reference. Preferably, the isolation system further includes a master controller which acts as an interface between one or more remote isolation station(s) and the control system, typically a plant control system, which may be implemented through central or distributed control. It is conventional for a plant control system to have a central control room (CCR) from which one or more control room operators (CRO) can monitor and/or effect control inputs to the plant control system. The master controller may conveniently be located in a suitable equipment room or within a sub-station and be provided with a HMI (Human Machine Interface) for allowing maintenance and other authorised personnel to access the status of the system, status of the isolation and any alarms/messages the system has generated. Such an HMI is additional to the HMI used at a remote isolation station.

Preferably, where equipment for isolation is under the control of, or otherwise in communication with an existing control system such as a DCS (Distributed Control System) or SCADA (Supervisory Control and Data Acquisition system) the remote isolation system, via the master controller, is provided with a control and diagnostic system such that status and alarms are visible from a plant control room.

Although complete isolation of equipment is required for safety purposes, it is possible to configure the system to selectively continue energy supply to ancillary component(s) of the selected equipment in certain exceptional circumstances. For example, in the case of conveyors, even when the conveyor itself is isolated, it may be necessary to maintain an energy supply to the conveyor braking system to ensure that braking action, prevention of conveyor movement, is achieved. Other components for other equipment could remain energised in this way. The plant control system controls such energization.

The plant control system may include means to over-ride an approved isolation, that is bypass the remote isolation system, in certain exceptional circumstances. Such over-ride, due to the risks involved, would typically require specific approval from senior personnel with safety precautions being taken such as through a permit type system. However, there may be instances where such over-ride or bypass mode is appropriate. There may be an error in the control system or other factors may be identified which make the isolation inappropriate or ineffective. In such situations, determined remote isolation stations may be disabled and the remote isolation station may be flagged as inoperative. Such flagging may be done in a number of ways. In one example, the isolation switch may be provided with a further state, an inoperative state, making its use ineffective. Other flagging techniques could be used either in addition or as an alternative.

A bypass of the remote isolation system may also provide a convenient means of commissioning a new system to an existing, (ie already operational) equipment. In this instance the remote isolation system can, for all practical considerations, be fully installed and tested except that the system is placed in the bypass mode. The remote or field isolation stations may be flagged as being in a non-use mode (for instance by covering each station, by having the isolation switch locked to a non-use position or by any other suitable means that provides a user with the knowledge that the field isolation station cannot be used to isolate the equipment in question. Upon completing the commissioning phase of the system, the system may be taken off bypass and become activated for use.

The isolation system may include means requesting “return to service” of equipment items or sets of equipment items that have been isolated. Such request means may form part of the human machine interface—whether provided in the form of a graphical user interface. buttons, switches or any other form of interface device—at a remote isolation station or other convenient location. When a “return to service” request is made, the control system checks whether return to service is acceptable, for example identifying that relevant equipment items have been de-isolated (if ever isolated). Comparison with other permissives for return to service may also be made. If return to service Is approved, the equipment can be returned to service by the plant control system (typically through the master controller of the system).

Where the equipment item is driven by a variable speed device such as a variable speed driver for a motor, electrical isolation may be achieved as above described. However, as a crash or hard stop could damage the motor, it is desirably avoided. In this case, the control system includes logic to enable the variable speed device or motor to proceed through a controlled stop sequence prior to isolation allowing the variable speed device to stop with reduced risk of damage.

The remote isolation system may include a warning system alerting personnel to an imminent isolation or de-isolation. Such warning is particularly important at the sub-station(s), where high voltage contactors are located, due to the risk of arc flash. Such warning system is therefore most usefully located at the sub-station. Warnings may take the form of visual and audible warnings, advantageously used in combination. Flashing lights, signs and strobes may be used in combination. Sirens and recorded voice message announcements may also be used. The warning system may be operated for a predetermined period prior to isolation. This period enables personnel inside the sub-station to safely evacuate the area. At the same time, personnel outside the sub-station are at least deterred from entering. Door locks may be actuated to prevent personnel entry to the sub-station(s) involved.

The remote isolation system may be retrofitted to existing equipment and plant.

The remote isolation system may involve implementing a method for isolating an equipment item as described in the Applicant's International Patent Publication No. WO2011/047428, the contents of which are incorporated herein by reference.

The control system may conduct a stored energy test to ensure that stored energy is safety released prior to isolation. Such stored energy test conveniently follows making of an isolation request. In the case of moving equipment, such as a conveyor, motion detection may be used to ensure that the equipment has come to a complete stop before isolation authorization is granted. For example, the control system may command release of conveyor brakes and then the conveyor belt may be monitored for movement. When the conveyor belt is confirmed stationary, the brakes will apply. The brakes will then be released again with the conveyor belt again being monitored for movement. This procedure may be repeated as many times as necessary until the control system confirms that the conveyor belt remains stationary with stored energy released permitting the remote isolation to proceed. It is to be understood that stored energy tests are not limited to motion detection. Other parameters such as temperature, pressure and so on may be relevant for conveyors and other equipment such as reactors, pipework and so on.

For example, where hydraulic conveyor brakes are used, brake fluid pressure may be monitored to ensure that brakes are in required state—engaged or disengaged—and to check that energy stored in the conveyor belt is safely released. In particular, hydraulic conveyor brakes disengage, or lift, above a particular hydraulic fluid pressure which may be set, by the system, as a control setpoint. Hydraulic fluid pressure above this setpoint may indicate potential for the conveyor to move (a potentially unsafe condition) and corrective action may be taken by the control system to avoid this hazard where hydraulic brake fluid pressure is monitored above setpoint. Hydraulic fluid pressure is measured by pressure transducer and these may be configured to avoid unauthorised pressure setpoint adjustment.

The isolation system, method and apparatus as above described may usefully be applied to a range of equipment and processes. For example, and without limitation, such equipment may include various types of conveyor (screw conveyors. vibrating conveyors etc), bucket elevators, screeners, crushers, feeders (vibro-feeders, feed-gates etc) all for use in material handling processes; fans, blowers and pumps.

The isolation system, method and apparatus should be subjected to a risk analysis to determine probability of failure and probability of mean time to failure. Risk analysis is undertaken during the engineering design phase where a HAZOP or like analysis is undertaken to identify risks Based on the risk analysis, a safety level or safety integrity level (SIL) is ascribed to the isolation system. A SIL rating of at least 2, and more preferably 3, is achievable with the system, method and apparatus as above described. The isolation system must be monitored periodically to ensure that the safety integrity level does not fall below a rated SIL level.

A number of preferred embodiments of the invention will now be described with reference to a conveyor belt system.

### BRIEF DESCRIPTION OF THE DRAWINGS

FIG. 1 shows a schematic layout of a remote isolation system as applied to a conveyor belt system.

FIG. 2 shows a further schematic of the remote isolation system shown in FIG. 1

FIGS. 3A to 3C show schematic layouts of a front panel of a remote isolation stations in accordance with first, second and third embodiments of front panel and remote isolation system.

FIG. 4 shows a more detailed view of one embodiment of a front panel of a remote isolation station.

FIG. 5 shows an isolation switch in the ready state.

FIG. 6 shows an isolation switch in the “isolation active state” prior to a padlock being applied.

FIG. 7 shows an isolation switch in the “isolation active state” subsequent to a padlock being applied.

FIG. 8 shows a cross-section through and isolation switch.

FIG. 9A shows a flow diagram for a first embodiment of remote isolation procedure.

FIG. 9B shows a flow diagram for a second embodiment of remote isolation procedure.

FIG. 10 shows a flow diagram for the remote de-isolation procedure.

FIG. 11 shows a partial detail schematic for a remote isolation system, similar to that depicted in FIG. 2 but applied to a medium or high voltage conveyor system with a variable speed conveyor drive.

FIG. 12 shows a partial detail schematic for a remote isolation system, similar to that depicted in FIG. 2, for a low voltage conveyor system with a variable speed conveyor drive.

FIG. 13(a) shows a schematic layout of the remote isolation system, as applied to conveyor belt systems, as described with reference to FIGS. 1 to 12

FIG. 13(b) shows a schematic layout of a further embodiment of remote isolation system for conveyor belt systems.

FIG. 14 shows a schematic of a control panel used at a control room for a plant including conveyor belt systems to be isolated in accordance with the further embodiment of remote isolation system.

FIG. 15 shows a schematic of a control panel used at remote isolation stations for conveyor belt systems to be isolated in accordance with the further embodiment of remote isolation system.

FIG. 16 shows a schematic of an alternative control panel, to that shown in FIG. 15, for use at remote Isolation stations of the remote isolation system of embodiments of the present invention.

FIG. 17 shows a detail perspective view of the isolation switch included within the control panel of FIG. 16 in de-isolated condition.

FIG. 18 shows a front view of the isolation switch of FIG. 17.

FIG. 19 shows a perspective view of the isolation switch of FIGS. 17 and 18 in isolated and locked condition with padlock or applied.

Similar reference characters denote corresponding features consistently throughout the attached drawings.

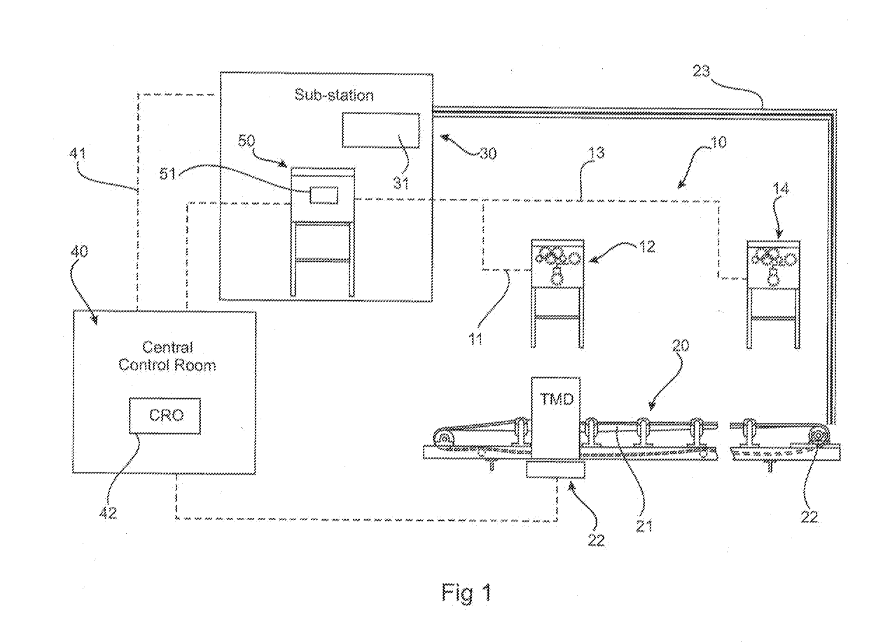

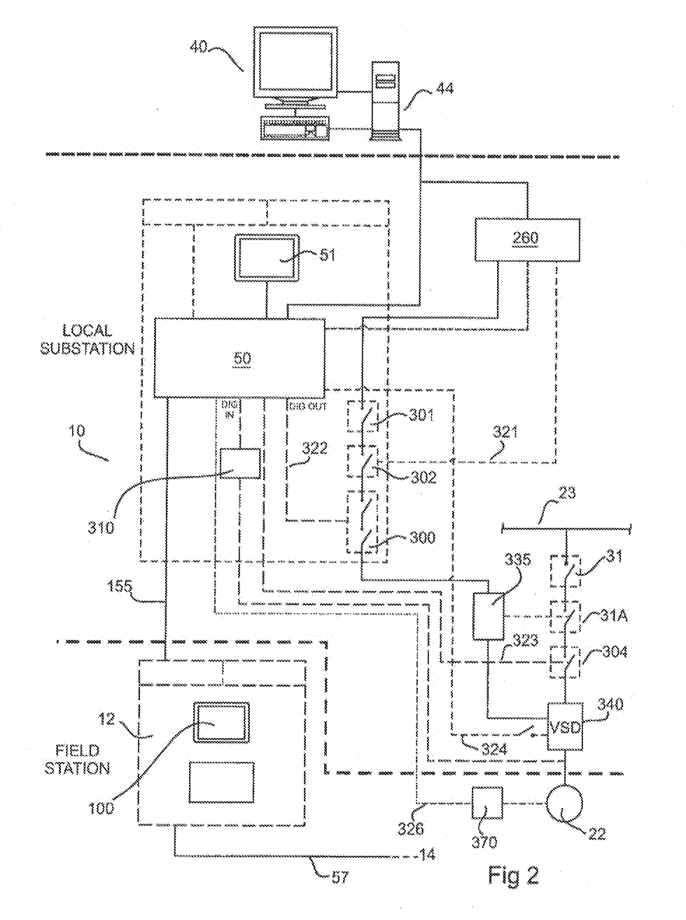

FIG. 1 shows a schematic layout of a remote isolation system 10, as retrofitted on an existing conveyor belt system 20 for example a long range conveyor system for conveying iron ore from a mine site to a port for shipment. The conveyor belt system 20 comprises a troughed conveyor belt, 21, having a head pulley motor 22 driven by an electrical supply through electrical contacts 31, whether contactors or circuit breakers, as illustrated in FIG. 2. One contact 31 is a standard contactor 31A for “ON”/“OFF” operation of the motor drive 335 for motor 22. The head pulley motor 22 is powered through motor drive 340 by a variable speed device (VSD) 340 which is electrically powered from a 3 phase AC power supply line 23 with voltage less than 1000 VAC. The electrical power is supplied from a sub-station 30. The sub-station 30 houses the contactors 31. Activation of the contactors 31 (ie placing them in the “off” or “break” state), de-energises all phases of the electrical supply to the conveyor head pulley motor 22.

The conveyor belt system 20 and sub-station 30 are under the control and supervision of a plant control system 260 having a central control room (CCR) 40, via a DCS (distributed control system) or SCADA (Supervisory Control and Data Acquisition system) 44 as are commonly used and would be well understood by the skilled addressee. Items 41 are representative of communication and control network between the CCR and the various other systems and components. A Control Room Operator (CRO) 42 is located within the CCR and has various input/output devices (I/O) and displays available (not shown) for the proper supervision and control of the conveyor belt system 20. Except for the remote isolation system, 10, the above description represents a conventional system.

The remote isolation system, 10, comprises remote or field isolation stations 12 and 14 which are located proximate to the equipment that they are intended to isolate, here conveyor belt system 20. The remote isolation system 10 also includes a master controller, 50. The master controller 50 incorporates a human/machine interface (HMI) here in the form of a touch sensitive screen, 51 which displays human interpretable information. The HMI could include less fragile switches or buttons to perform the same duty. The master controller 50 is placed within the sub-station 30. The remote isolation stations 12 and 14 are in communication with master controller 50, communication line 155 for remote isolation station 12 being shown, and each other, via communication channels 11, 13, 155 and 57 (in FIG. 2) respectively. These communications channels 11, 13, 155 and 57 may be in any suitable form including hard wired or wireless forms.

FIG. 2 shows a further schematic of the remote isolation system 10 shown in FIG. 1 highlighting the control and communications systems. First circuit interrupters being a set of isolation contacts 300 are placed in series connection with an emergency stop switch 301 and a primary stop/start switch 302 (the latter two of which would normally be found in a conventional system). First circuit interrupters 300, and switches 301 and 302 form part of the control system that controls second circuit interrupter(s) 304, for low voltage applications contactor(s), in accordance with the invention.

Second circuit interrupter 304 is a critical element of the remote isolation system 10. Dependent on the voltage of the system, second circuit interrupter(s) 304 will be contactor(s) (low voltage) or rackable circuit breaker(s) (high voltage). Contacts 300, forming an important part of the remote isolation system 10, are in the form of a plural switch which incorporates self diagnostics and is designed so that a loss of power results in the contacts 300 moving to the off or break state.

FIG. 2 shows provision of a digital out (“DIG OUT”) control line 321 to the stop-start switch 302 not necessarily controlled by the remote isolation system. 10, rather being controlled by plant control system 260. Remote isolation system 10 may control stop-start switch 302. This control line 321 is not relied upon to achieve isolation of conveyor belt system 20 though it may be used to sense that a current isolation is in effect. Master controller 50 controls both the first circuit interrupter 300 and the second circuit interrupter 304 as shown by control lines 322 and 323 respectively.

A voltage monitor or relay 310 senses and monitors the voltage down-stream of the second circuit interrupter 304. Although not shown in FIG. 2, the voltage monitor 310 senses and monitors each of the individual 3 phases supplied to the motor 22 and provides a status signal to the master controller 50. The voltage monitor 310 is a device certified for safety compliance and incorporates self diagnostics because its role is to ensure that risk of continued energization of conveyor belt system 20 following an authorized isolation is prevented. For voltages above about 600 VAC, the voltage monitor 310 may incorporate a voltage transformer (not shown) to step down the voltage for final sensing and monitoring.

Zero speed sensor 370 is included to provide further safety assurance that the head pulley motor 22 and conveyor 21 is not running. Master controller can implement the correct action if zero speed sensor 370 sends a signal inconsistent with isolation (see control line 326). Zero speed sensor 370 may also be used in a stored energy test routine as described further below.

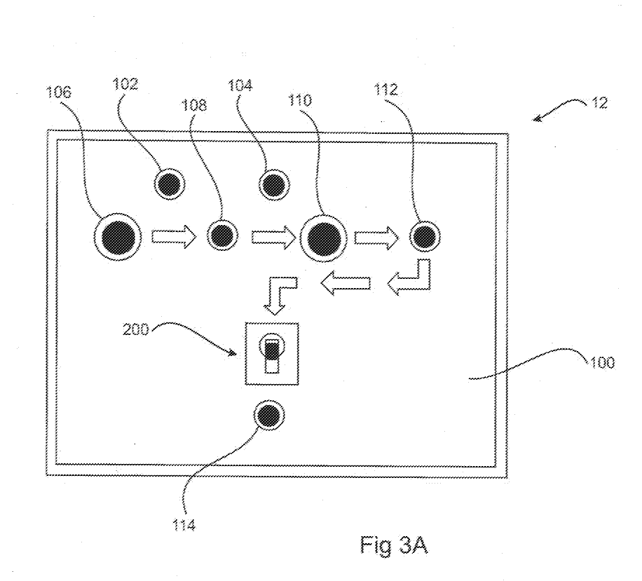

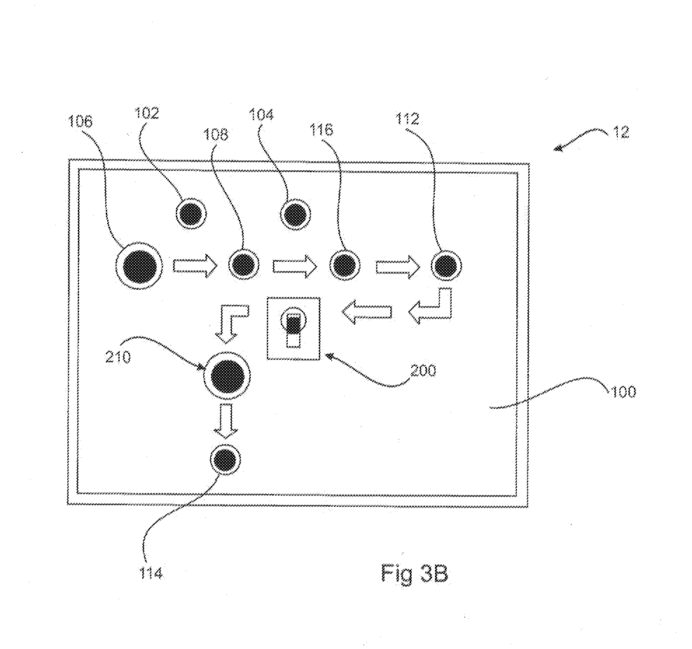

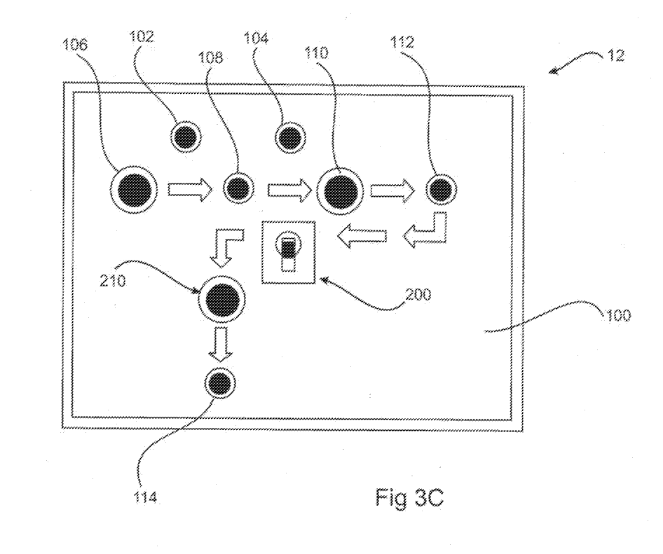

The front panel 100 of either of the remote or field isolation stations 12 and 14 is shown in alternative schematic forms in FIGS. 3A to 3C which shows the panel 100 in the normal state (that is, when no isolation is in effect). FIG. 4 shows a further variation of the front panel 100 which includes additional graphics and instructions which aid in the proper operation of the remote isolation system.

Front panel 100 has a first indicator means in the form of status indicator light 102 which glows to indicate that the remote isolation system 10 is ready and available for an isolation request, a first human machine interface in the form of a manual device, an isolation request button 106 which an operator presses to commence the isolation request, a second indicator means in the form of an isolation authorization indicator light 108 which initially flashes to indicate that an isolation request has been made and subsequently glows solid if the request has been granted, and a manual isolation switch 200, which the operator operates to secure the isolation (further details of the isolation switch 200 are provided below). The front panel 100, of FIGS. 3A and 3C. also includes a second manual interface means in the form of a “try start” button 110 pressed by the operator, prior to isolation, to ensure that the conveyor belt 21 does not start.

Front panel 100 of FIG. 3B forms part of a remote isolation system 10 with the plant control system 260 configured to enable an automated or virtual “try start”. Indicator means, in form of indicator light 116, shows when the plant control system 260 has requested the virtual try start.

Front panel 100 of FIGS. 3A to 3C also includes a third indicator means in the form of a “proceed to isolate” light 112 which glows steady once the try start test has been successfully completed (ie a fail to start signal is registered by the control system).

Front panel 100 of FIGS. 38 and 30 also include a manual interface means in the form of “try start” button 210 which is pressed by the operator to ensure that the conveyor belt 21 does not start. For the front panel 100 of FIG. 3B, this is the second manual interface means. For the front panel 100 of FIG. 3C, this is the third manual interface means. Try start button 210 is pressed after the operator has operated manual isolation switch 200 to secure the isolation.

Further display means in the form of an “isolation complete” indicator light 114 is also included, in front panel 100 of FIGS. 3A to 3C, to clearly indicate that an isolation is in effect. The suite of indicator means provide a human interpretable display. The front panel 100 generally may also form part of such display.

The front panel 100 shown in FIG. 4 is similar to that of FIG. 3A though has a set of additional indicator lights 121, 122, and 123 for indicating that a voltage is present on each of the respective 3 phases of electrical power provided to the equipment. When the conveyor system 20 is in the normal operating state all of the lights 121, 122 and 123 will be on and the light 102 will be off (indicating that the system is not ready for isolation). However, in the event that conveyor belt 21 has been stopped (for instance, as a result of detection of tramp metal by the Tramp Metal Detector 22) and the primary circuit breakers 304 have been placed in the break state, any one of the lights 121, 122 or 123 remaining on will indicate a fault and light 104 will illuminate. Such a situation may arise if one or more of the lines of the second circuit interrupter(s) 304 has welded and failed to break. In this case light 102 will also remain off to indicate that the system is not ready.

Indicator lights 102, 104, 108, 112, 114 and 116 (where applicable) are all monitored for proper operation by a diagnostic check (for example by applying a test voltage—preferably insufficient to illuminate the light—and checking for an open circuit). For this reason, incandescent lights may prove more economical over and above alternatives such as Light Emitting Diodes (LED's) as checking for a circuit through the light filament is a relatively simple process. Multiple indicator lights and/or multi-filament bulbs may also be incorporated for additional reliability and longevity before replacement is required. The system is configured so that any fault will be reported to the master controller, 50, and thereby to the CCR. A fault in the remote isolation system 10 will render the system to the “last known state” in a fail-safe manner. If LED's are to be used, suitable diagnostics can be applied to provide fault detection (for example a photo-sensitive resistor may be used to positively confirm that the LED is illuminating).

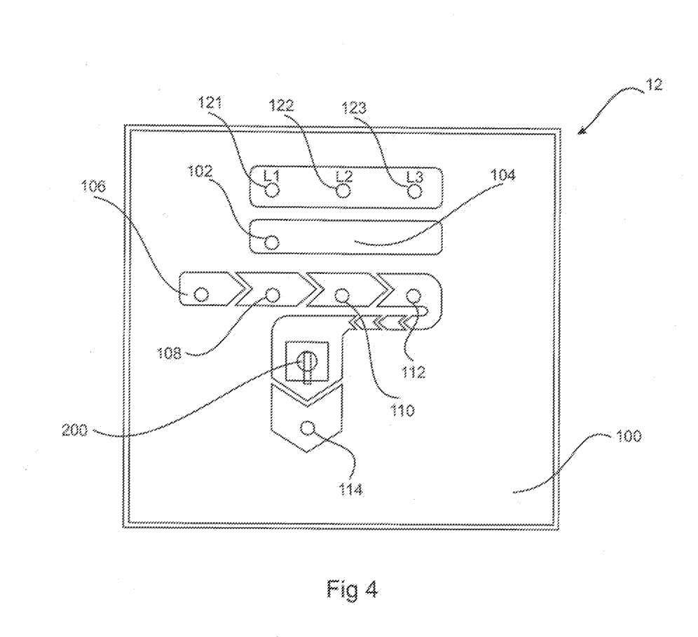

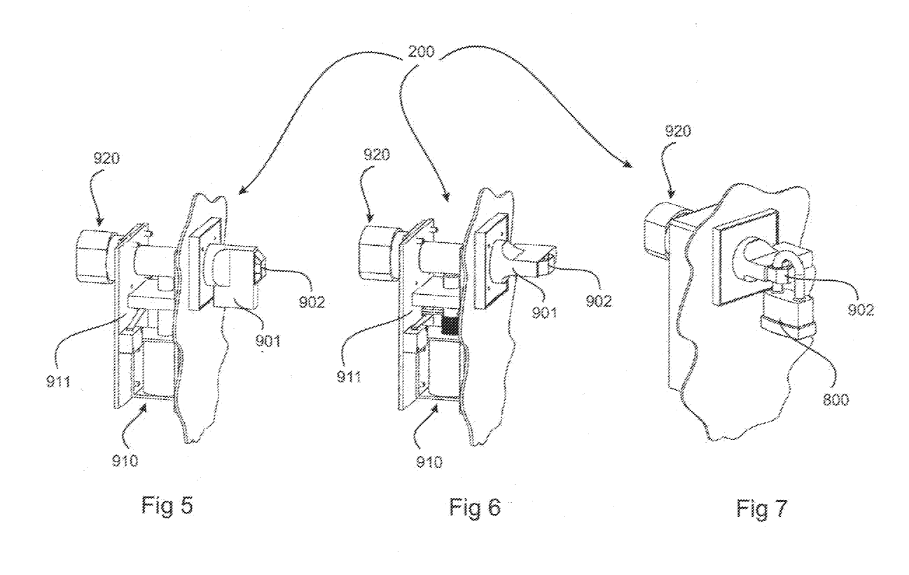

FIGS. 5, 6 and 7 show the remote isolation switch 200 in various states. FIG. 5 shows the isolation switch 200 in a first state, being in a normal state as seen in FIGS. 3 and 4. FIG. 6 shows the remote isolation switch 200 in a second state, namely an isolation state, before any personal locks have been secured to the isolation switch 200. FIG. 7 shows the isolation switch 200 in the isolation state and with a padlock 800 applied to secure the isolation. Whilst the isolation switch 200 is in this “isolation active” state, de-isolation of the conveyor belt system 20 cannot occur and run contacts 300 cannot be closed.

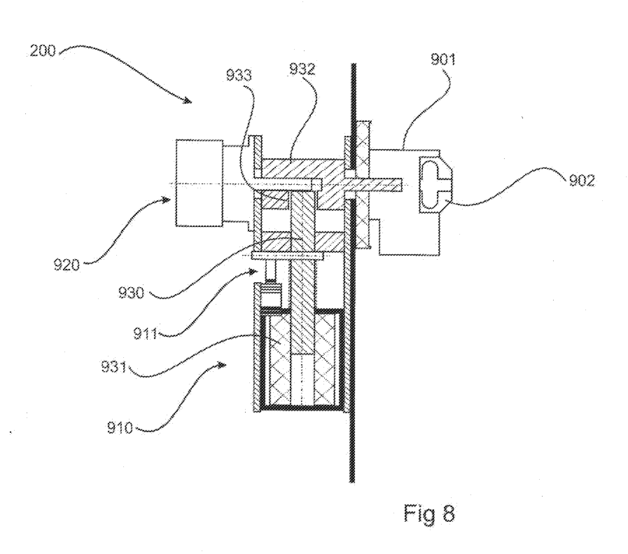

As may be best seen in FIG. 8. isolation switch 200 comprises a manual interface portion in the form of a plastic handle 901, an interlock means, in the form of a solenoid 910, an interlock sensor means in the form of a reed micro-switch 911. a state detection means in the form of a two-state contact switch 920, and a locking means in the form of a lockout hook 902.

Isolation switch 200 is configured such that lockout hook 902 does not become accessible to the operator unless and until the handle 901 is positioned to the “isolation active” state which should be after a “try start” step, as described below, is completed.

Solenoid 910 includes an actuator pin 930 which is actuated by an electrically powered coil 931. A shaft 932 connects the isolation switch handle 901 to the two-state contact switch 920 so that rotation of the plastic handle 901 is transmitted by the shaft 932 to the switch 920. Shaft 932 includes an aperture 933 which receives the actuator pin 930 when the handle 901 is in the “ready” state orientation and prevents shaft 932 rotating when so engaged. The actuator pin 930 is biased by a biasing spring (not shown) to the upward direction (as viewed in FIG. 8) when the solenoid 931 is in the de-energised, or off, state. The micro switch 930 detects that the actuator pin 930 is engaged with the aperture 933 (the micro-switch only being activated upon a pre-determined displacement of the actuator pin which corresponds to engagement with the aperture 933.

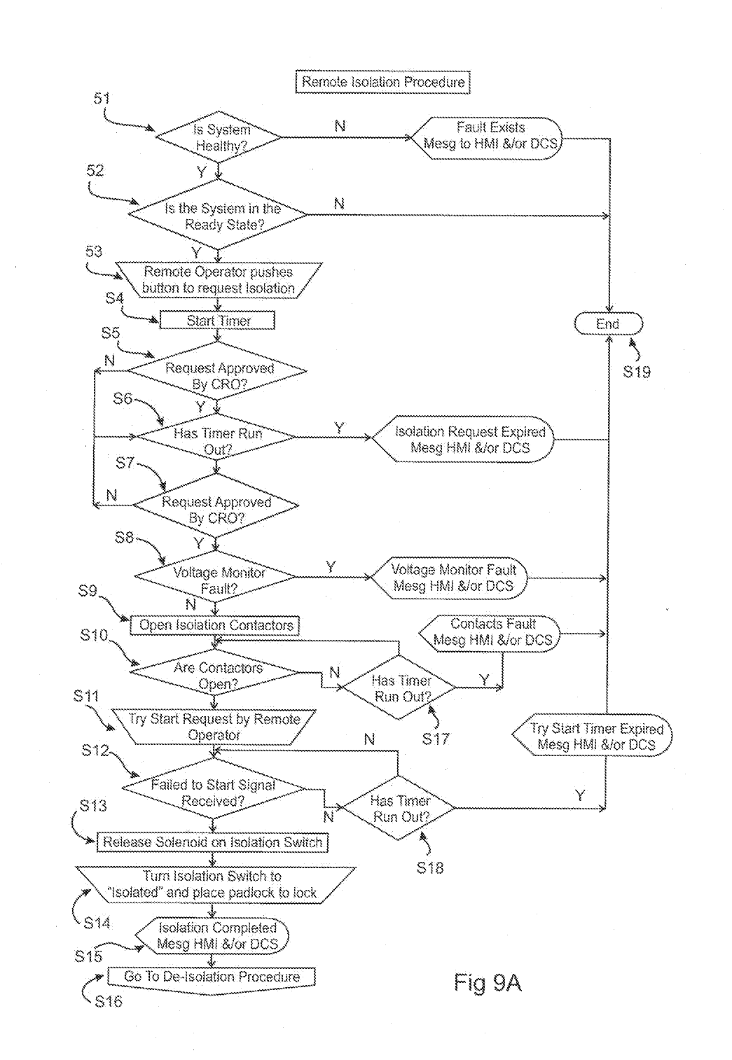

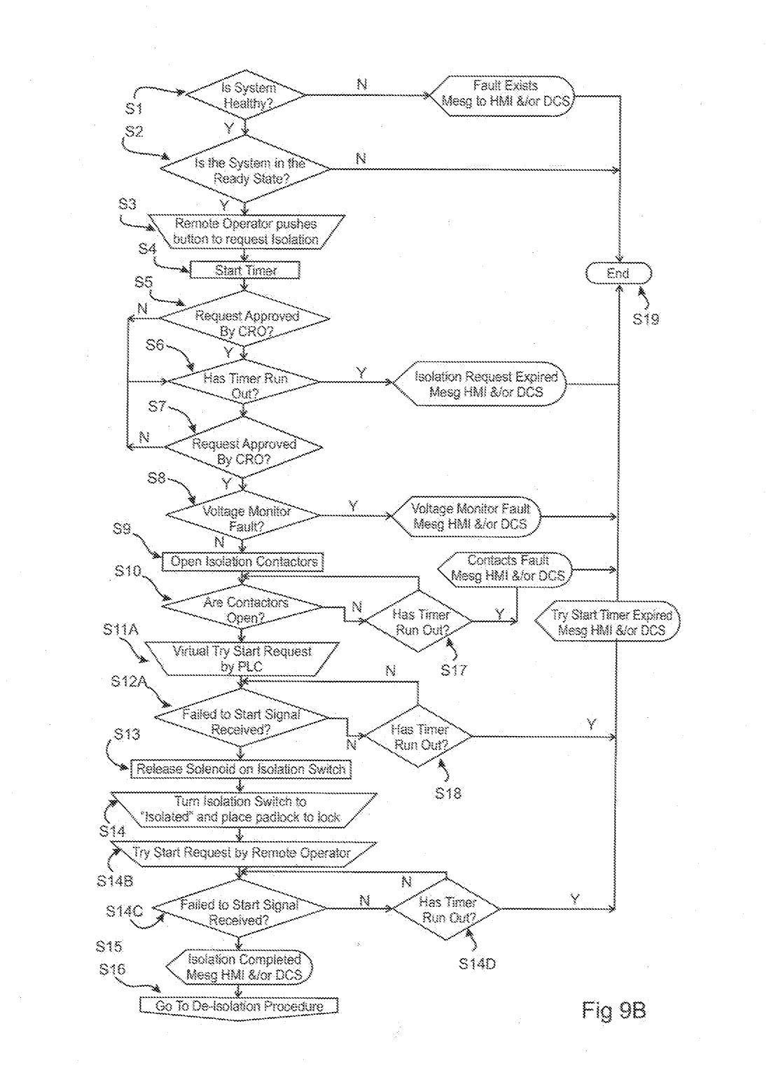

Operation of the remote isolation system 10 will now be described with reference to the generalised logic flow chart shown, in a first embodiment, in FIG. 9A and, in a second embodiment in FIG. 9B. The procedures described with reference to FIG. 9A differs from the procedure described with reference to FIG. 9B in relation to the try start step to be described further below.

At step S1, the system undergoes a health check for any existing faults or alarms that would prevent an isolation request from being granted, approved or authorised. If no relevant faults exist, then step S2 checks whether the system 10 is in a ready state. In the case of the conveyor system 20 shown in FIGS. 1 and 2, conveyor 21 must have come to a complete stop, as sensed by zero speed sensor 370, and the voltage monitor or relay 310 must indicate that no voltage exists on any of the 3 phase supply lines before the system is deemed to be in a ready state. If step S2 is satisfied, the indicator light 102 will glow solid on the remote isolation station panel 100 (as seen in FIGS. 2 and 4). If not then a flag or fault message will be generated at the master controller HMI, 51, and/or at the CCR.

At step S3, an operator situated at a remote isolation station (for example station 12 of FIGS. 1 and 2) pushes the isolation request button 106. This request is forwarded through communication line 155 to master controller 50 and plant control system 260 and onward to the CCR. The indicator light 108 then flashes to indicate registration of the request by plant control system 260. The request is pending at this stage. Step S3 results in a signal being sent to the CCR which may be displayed for the attention of a CRO. At the CCR, either the control system itself or a CRO considers the isolation request and makes a determination whether to grant the request or not. At step S4, a time-time out timer is started. This timer may be set for any convenient period, for example 5 minutes.

At Step S5, the system 10 awaits grant of an isolation approval from the CCR and/or the CRO. The CRO may determine that the isolation may be approved, possibly after interrogation of the operator to assess whether permissives to isolation have been met, in which case the CRO may confirm approval of the isolation request by activating switch or via a mouse click where a suitable human machine interface is provided. Permissives may include requesting operator skill level, consistency of the isolation request with known operating state of the conveyor belt system 20 and so on.

Step S6 is a check that isolation approval is granted within the timer period. If not a timer expire message is issued and the process moves to Step 19 in which case the status quo of the system is maintained (in this case, no isolation has been effected).

Step S7 is part of the timer loop which checks that an approval has been received during the preset time. Thus inaction by the CRO, or a positive decision by the CRO not to grant approval of an isolation request will result in a time out and moving to Step S19. Inaction by the CRO may be permitted by system 10 where the operator requesting approval of an isolation request has received prior authorization for isolation, for example due to the operator's skill level. That is, certain permissives for isolation may effectively be met prior to making of an isolation request.

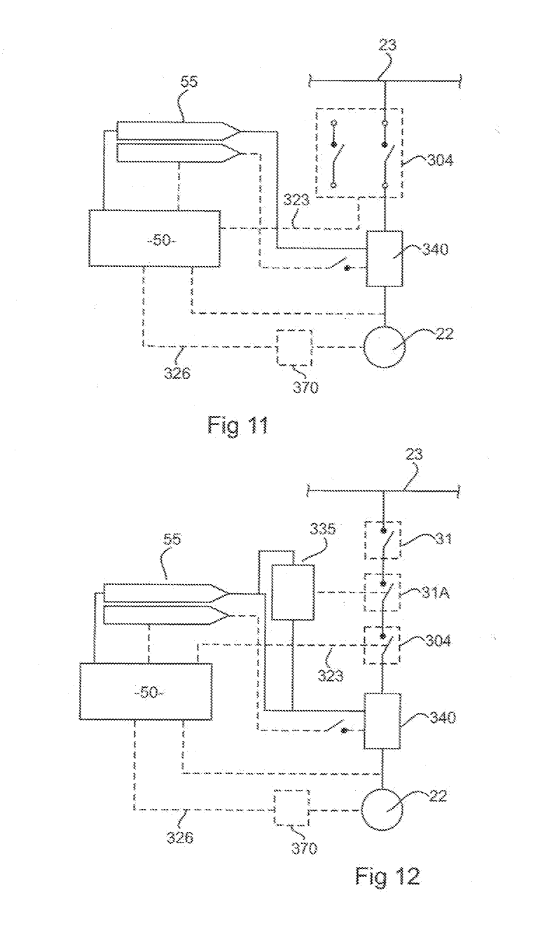

At step S8, plant control system 260 checks the status of the voltage monitor 310 (per FIG. 2). At this stage. the stop/start switch 302 should already be in the off or break state such that the second circuit interrupter 304 is also in the off or break state as shown in FIGS. 2 and 12. Where the voltage in the energy supply or load line 23 to conveyor belt system 20 is in excess of about 1000 VAC, second circuit interrupter 304 may be comprised by rackable circuit breaker(s)—as conveniently illustrated in FIG. 11—and moving circuit breaker(s) to a break state involves a controlled racking out process where a break of the electrical circuit is visually confirmed. Circuit breaker(s) 304 may be locked in break position by locking pins. The locked position may be sensed and indicated at remote control station 12 and the CCR. The locked position may also be communicated to master controller 50 and indicated at remote control station 14 communicated with remote isolation station 12 through communications line 57 (per FIG. 2).

Provided that a zero voltage status is returned by the voltage monitor or relay 310 the remote isolation system 10 moves to step S8 wherein the first circuit interrupters 300 are placed in the off or break state creating a further point of isolation. Personnel located at sub-station 30 are alerted by a warning system, prior to breaking circuit breakers 304 and circuit interrupters 300, that isolation is about to take place. The warning system may provide warnings in the form of visual and audible warnings, advantageously used in combination. Flashing lights, signs and strobes may be used in combination. Sirens and recorded voice message announcements may also be used. The warning system may be operated for a predetermined period prior to isolation. This period enables personnel inside the sub-station to safely evacuate the area. At the same time, personnel outside the sub-station 30 are at least deterred from entering. Door locks may be actuated to prevent personnel entry to the sub-station(s) involved.

The system has now been isolated at two points of isolation—in the control circuit and the energy supply line 23—by first circuit interrupters 300 and second circuit interrupters 304—all under supervision of plant control system 260. Works on conveyor belt system 20 may proceed.

As there is some delay in the operation of the first circuit interrupters 300, including for safety reasons as above described, step S9 (“open isolation contactors”) performs a check to confirm that the first circuit interrupters 300 are in the off or break state as required for isolation. The first circuit interrupters 300 are provided with self diagnostics and are able to report their status to the master controller 50. If the system does not register that the first circuit interrupters 300 are in the off or break state within the timer period then a fault flag is generated and the remote isolation system 10 moves to step S9 in which the last known state of the system is maintained.

If Step S10 is passed, then indicator light 108 is made to glow solid or steady at a panel of remote isolation station 12. A similar indicator light may also operate at remote Isolation station 14 as both stations are communicated with the master controller 50 and plant control system 260.

Step S11 of the procedure, schematically illustrated in FIG. 9A, requires the remote operator to press the button 110 on the remote isolation station panel 100 (see FIGS. 3A. 3C and 4) in a try start test step.

The operator need not press a button to implement a try start test step following the procedure schematically illustrated in FIG. 9B. In that procedure, the operator takes no active part in requesting a try start. Rather, the plant control system 260 requests an automated or virtual try start. A try start, whichever procedure is used, results in the plant control system closing the start/stop switch 302. The plant control system 260 monitors one or more sensors and/or inputs to determine if the conveyor 21 and/or motor 22 have started (see FIG. 1).

Steps S12 and S18 provide a timed loop to check that the try start test, as required by safety guidelines, has been passed (a pass being registered if a failed to start signal has been issued by the plant control system 260—otherwise the step will time-out and a fail flag will be registered). Steps S11, S12 and S18 may not be required in certain jurisdictions or at certain mine sites.

At Step S13 the indicator light 112 glows solid or steady. At that point, the solenoid coil 931 is activated and the pin 930 is retracted from the aperture 933. The operator then turns the handle 901, at step S14, which places the isolation switch 200 in the “isolation active” state which is sensed by the two-state contact switch 920 and a corresponding signal is issued to the master controller 50. The remote operator then pulls out the padlock hook 902 and places his personal padlock (or a hasp to which a plurality of personal locks may be secured).

The remote isolation is now complete and secured at step S15 following the procedure schematically illustrated in FIG. 9A. The “isolation complete” indicator light 114 glows steady However, additional steps S14B to S14D are included in the procedure schematically illustrated in FIG. 9B before isolation is complete and secured at step S15. Steps S14B to S14D which provide for a manual try start request by the operator, following step S14 in a manner similar to that described for the manual try start of steps S11 and S12 of the procedure of FIG. 9A. Following step S14, step S148B of the procedure schematically illustrated in FIG. 9B, requires the remote operator to press the button 210 on the remote isolation station panel 100 (see FIG. 3B) in a further try start test step. This step results in the plant control system closing the start/stop switch 302. The plant control system 260 monitors one or more sensors and/or inputs to determine if the conveyor 21 and/or motor 22 have started (see FIG. 1).

Steps S14C and S14D provide a timed loop to check that the try start test, as required by safety guidelines, has been passed (a pass being registered if a failed to start signal has been issued by the plant control system 260—otherwise the step will time-out and a fail flag will be registered). Steps S14C and S14D may not be required in certain jurisdictions or at certain mine sites.

Some other features of the remote isolation system 10 may also be described. First, the plant control system 260 allows for the variable speed drive for motor 22 driving conveyor 21 to proceed through a pre-programmed stop sequence to avoid a crash or hard stop that could damage the variable speed drive 340. Such control is supervised through logic drives 55 supervised by master controller 50 as schematically shown in FIGS. 11 and 12. Second, conveyor system 20 includes a braking system (not shown). Power supply may, in exceptional circumstances, be continued to the conveyor braking system so that brakes are operable, for safety reasons, during works performed on conveyor belt 21.

Before isolation, a stored energy test may be performed to ensure that conveyor belt 21 is stationary and that stored energy has been released Zero speed sensor 370 may be used to ensure that the conveyor belt 21 has come to a complete stop before isolation is completed and indicator light 114 illuminates. For example, plant control system 260 may command release of conveyor brakes and then the conveyor belt 21 may be monitored for movement by sensor 370. When the conveyor belt 21 is confirmed stationary, the brakes will apply. The brakes will then be released again with the conveyor belt 21 again being monitored for movement by sensor 370. This procedure may be repeated as many times as necessary until the plant control system 260 confirms that the conveyor belt remains stationary with stored energy released permitting isolation to be completed.

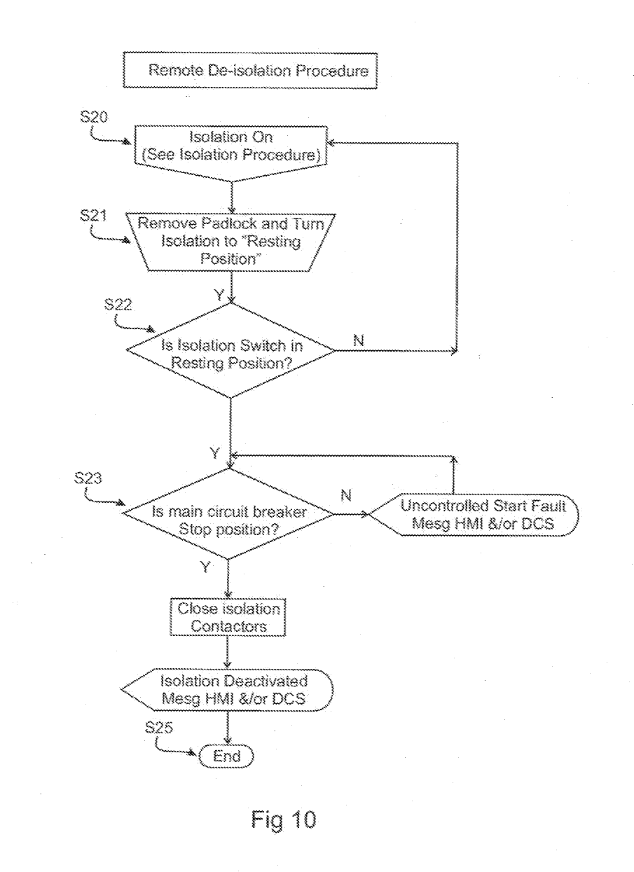

Reference is now made to the remote de-isolation procedure as indicated in FIG. 10. At Step S20 of FIG. 9B, the remote operator removes his personal padlock from the padlock hook 902 of the isolation switch 200, the hook 902 is pressed into its in-active state and the operator turns the handle 901 back to the “ready” state. This action is sensed by the switch 920 and a signal is sent to the master controller 50 to indicate that a de-isolation has been requested. The biasing spring (not shown) acting on the solenoid pin 930 urges the pin 930 into the aperture 933. The operator is now no longer able to operate the isolation switch without proceeding back to Step S1 described above.

Step S22 checks that the isolation switch 200 is back to the “resting state”. This is done via sensing the state of the two-state switch 920. If so confirmed, the system proceeds to Step S23. Step S23 is intended to prevent an “uncontrolled start” by ensuring that the stop-start switch 302 in the off position so that re-activation of first circuit interrupters 300 will not result in an activation of the second circuit interrupter 304 and thereby a re-energization of the conveyor 21. If Step S23 is failed, a flag is raised and the system holds its current state. If Step S23 is passed, the process moves to Step S24 (“close isolation contactors”) in which the first circuit interrupters 300 are activated to the close, or make, state. The de-isolation is now complete and the CRO or plant control system can proceed to re-start the conveyor belt system 20 according to normal procedures.

Remote isolation system, 10, is in the form of a programmable electronic system (programmable logic controller) dedicated to providing safe remote isolations for the conveyor belt system 20 whenever required for maintenance or other works purposes. The remote isolation system 10 is designed for the safe remote isolation of the conveyor belt system 20, without need for an Electrical Isolation Officer or Electrician to follow a complex protocol as above described. This form of isolation is primarily intended for mechanical works and to minimise production downtime during short term isolations for minor mechanical works such as clearing jams and blockages. The system may however be adaptable for other forms of isolation.

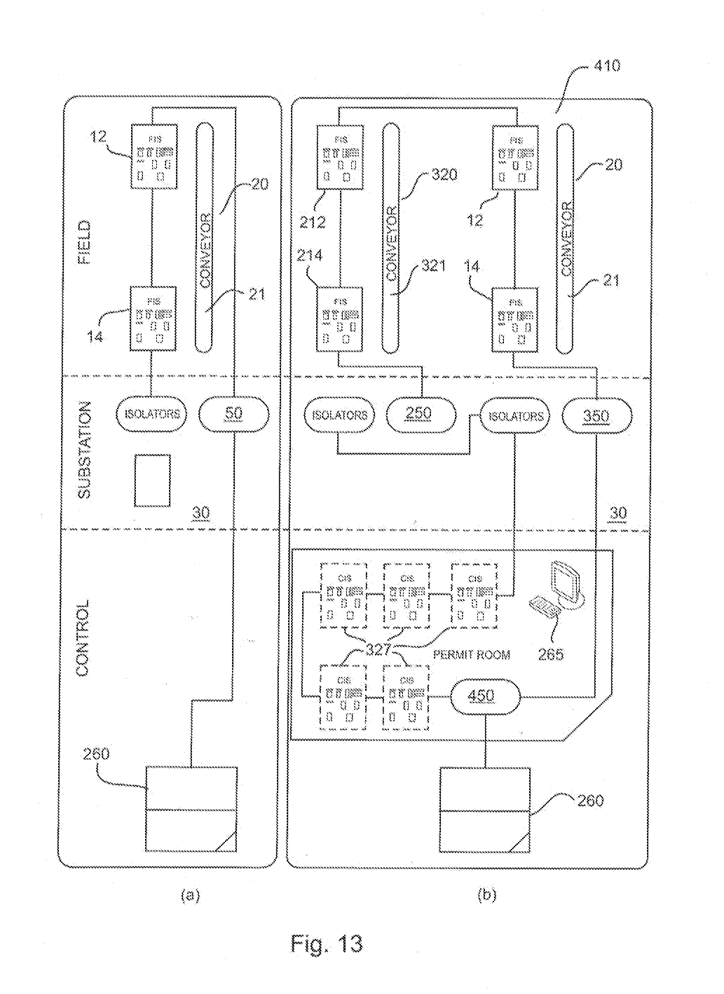

In accordance with advantageous non-limiting embodiments of the invention, as now described with reference to FIGS. 13(b) to 15, the remote isolation system 410 may be configured as follows. A plant includes conveyor belt systems 20 and 320, these comprising sets of equipment items for isolation. Conveyor belt systems 20 and 320 include respective conveyor belts 21 and 321, both being as described for conveyor belt system 20 above. Each conveyor belt system 20 and 320 includes two remote isolation stations 12 and 14 (for conveyor belt system 20) and two remote isolation stations 212 and 214 (for conveyor belt system 320). Isolators for both conveyor belt systems 20 and 320 are located in sub-station 30. These isolators correspond with those described above.

Plant control system 260 controls operation of the isolators through master controllers 250 and 350, these master controllers having the same function as master controller 50 above.

Conveyor belt systems 20 and 320 may require shut down for scheduled maintenance purposes. To this end, plant control system 260 includes selecting means for selecting conveyor belt system 20 for isolation. If selection and isolation is approved, plant control system 260 includes means to command an isolation module to isolate the conveyor belt systems 20 and 320. The selection/isolation procedure is under control of grand master controller 450 forming part of the plant control system 260. This grand master controller 450 is not included within the plant control system 260 described with reference to FIGS. 1 to 12 (and again schematically shown for ease of reference in FIG. 13(a)).

A human machine interface, 265 or 1265, included in the plant control system 260, and providing input to grand master controller 450, is a selection means enabling the CRO 42 to select conveyor belt systems 20 and 320 as sets of equipment items for isolation. These and other equipment items may have identifiers stored in a database that is accessed during the selection process through the interface 265/1265. The interface could be a computer 265, such as a PC, with a graphic user interface which, for example, allows the CRO 42 to select the conveyor belt systems 20 and 320 for isolation. During the selection step, the CRO 42 configures the isolation, using the selection means (computer 265), to correspond with plant maintenance requirements.

During configuration, the CRO 42—with the assistance of plant control system 260—selects isolation stations (configurable isolation stations or CIS) which are required to be isolated to shut down conveyor belt systems 20 and 320. Plant control system 260 and grand master controller 450 may generate the configurable isolation stations 327 in accordance with particular rules, perhaps developed to simplify the isolation procedure. These configurable isolation stations (CIS) 327, as indicated in FIG. 13(b) and here serving equivalent function to remote isolation stations 12, 14, 212, 214, are selected and a record of them is stored in the plant control system 260. One way to select the CIS isolation stations is through a “drag and drop” procedure, familiar to computer users. In such case, a list of plant equipment item identifiers, as stored in a database could appear in a window on the graphic user interface. The conveyor belt systems 20 and 320 are highlighted from this list and dropped into a list of equipment items to be isolated during the maintenance works. The plant control system 260 and grand master controller 450 may check, at this time, that the selection of equipment items for isolation is correct.

The equipment item database may be updated as new equipment items are commissioned and other equipment items are decommissioned.

When such configuration of isolation stations 327 is complete, a procedure to isolate conveyor belt systems 20 and 320 starts. This procedure may be started, for example, by the CRO 42. It will be understood that other operators could select equipment items for isolation. Further, the equipment items need not be selected using a human machine interface 265 located in the central control room (CCR). The CCR is a convenient choice of location and whatever location is selected is to be designated the “permit room”. A virtual “permit room” may also be established by the plant control system 260.

Control system 260 still performs approval and checking steps to ensure that isolation of the conveyor belt systems 20 and 320 is consistent with a current set of permissives. Such permissives could include conditions as described above with respect to the flow diagrams of FIGS. 9A, 9B and 10. However, selection for isolation of conveyor belt system 20 may be compared with a maintenance schedule or known maintenance history or operating state of the conveyor belt system 20. If there is inconsistency between selection for isolation and need for isolation, then the conveyor belt systems 20/320 are deleted from equipment items selected for isolation. Approval and checking steps also allow for error correction. If conveyor belt system 20 had been incorrectly selected for isolation, or an incomplete list of equipment items in the conveyor belt system 20 had been selected, the error could be corrected prior to isolation and costs of unnecessary shutdown (which may be very significant) avoided.

Safe isolation may be confirmed by patrolling remote isolation stations for conveyor belt system 20 to ensure that permit isolation has been carried out correctly. Keys for the isolation switches may be returned to the permit room as additional check for safe isolation of conveyor belt system 20.

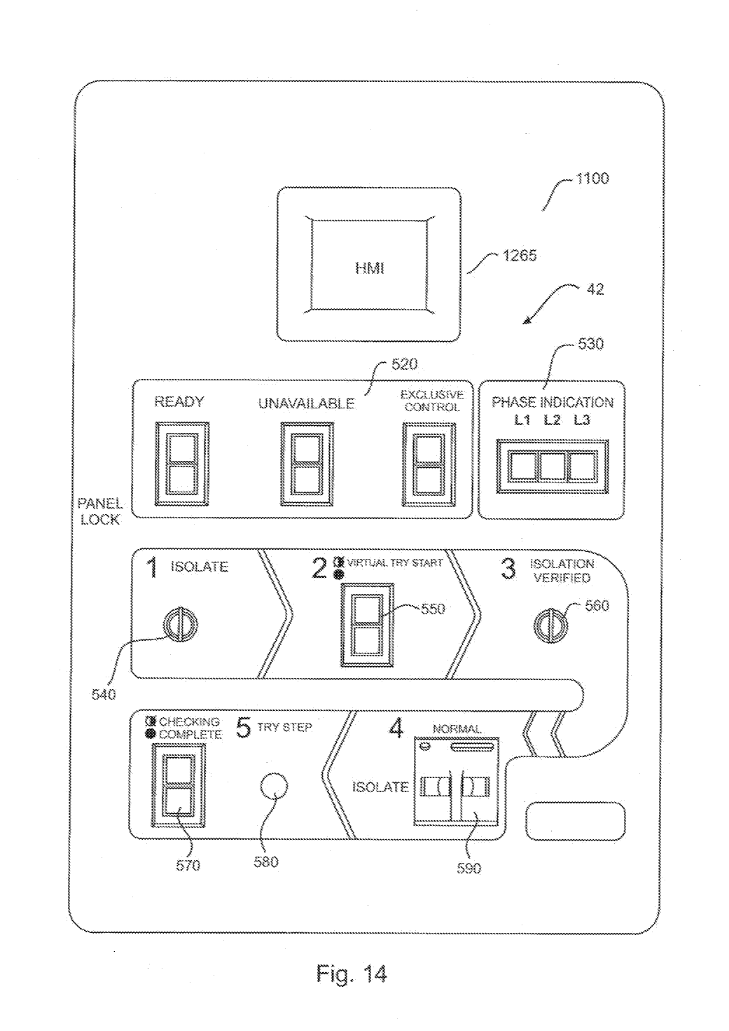

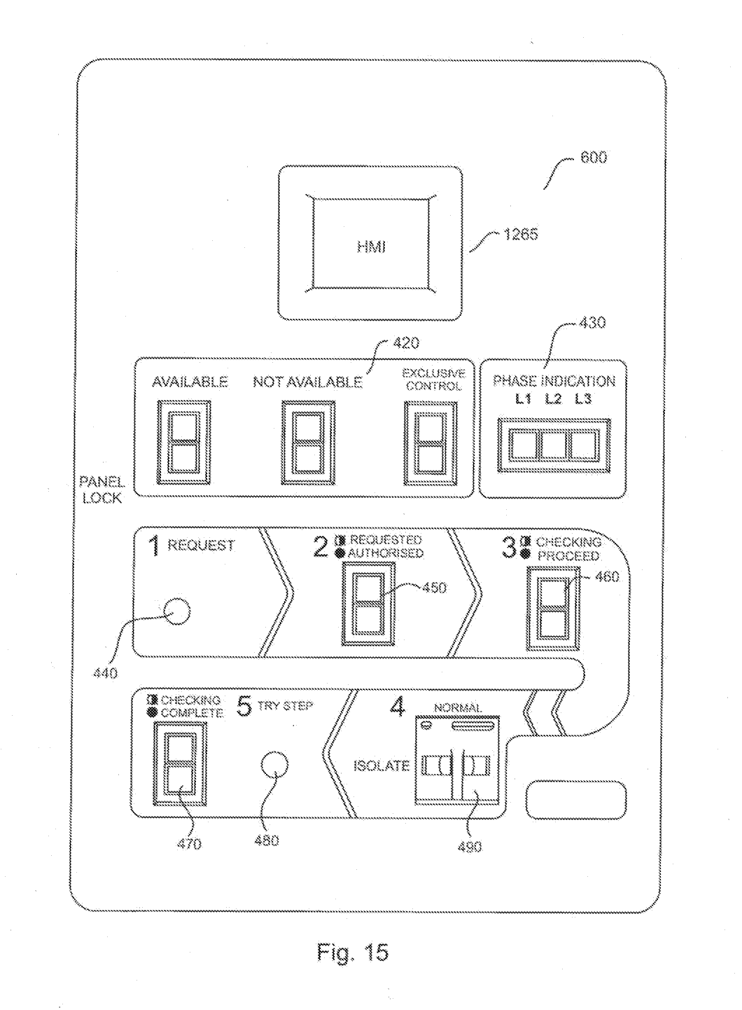

FIGS. 14 and 15 show schematics of respective panels 1100 and 600 located at the control room (configurable isolation station) and remote isolation stations using the remote isolation system of this embodiment of the invention.

At the CCR, there is provided a panel 1100, as shown schematically in FIG. 14, having a graphic human machine interface (HMI), including a touch screen 1265, for issuing isolation requests and other commands. Information can also be presented on screen 1265. Panel 600 also includes indicator lights in block 520 showing whether a remote isolation station, correspondent with conveyor belt system 320 (in this case), is available or not available for isolation. Conveyor belt 320 is selected as an example. Block 520 indicator lights may also indicate if a conveyor belt system 320 is under exclusive control of the configurable isolation station and CRO.

Block 530 indicates whether each phase of a three phase motor for driving conveyor belt 321 is energised or not. Permit isolation requires all three phases to be de-energised and indicator lights L1, 12 and L3 will each be in an off state when the conveyor belt system 320 is isolated.

When conveyor belt system 320 is selected for isolation, the CRO 42 inserts a key into lock switch 540 invoking isolation. In this case, insertion of the correct key and the CRO's authority level is sufficient to implement isolation. Following isolation, an automated or virtual try start is initiated, the result for which is indicated by indicator light 550. When the try start step is successfully passed, the CRO 42 must operate a further lock switch 560 using the same key as used for lock switch 540. This provides a further check on isolation. The CRO may implement a procedure that the switch 560 will not be activated until the CRO 42 has visually confirmed that the equipment to be isolated (i.e. conveyors 20 and 320) have in fact ceased motion. Zero speed sensor 370 may be used in this determination.

Isolation switch 590 is then operable and the CRO 42 may lock the conveyor belt system 320 out by operating the isolation switch 590. At this point, also, the CRO may activate and place his personal padlock on isolation switch 590.

Following this operation of isolation switch 590, conveyor belt system 320 is isolated and indication of this state is displayed on panel 1100 and at panels 600 at the dedicated remote or field installation stations 212 and 214 showing that local isolation is “not available”. Further functionality of panels 600 is described below.

A further step in the procedure acts as further confirmation of isolation being effected. Upon the CRO 42 pressing button 580, a manual try start is implemented. On successfully passing the manual try start test, the indicator lights 570 notify the CRO 42 that the isolation is in effect and that all necessary checks have been successfully completed. An indication is provided at block 530, that is, indicating no power—in any phase—to conveyor belt drive motor, to show when the try start test is passed. Interface 1265 may also display that the conveyor belt systems are isolated.

The isolation system still must complete checking for safe isolation of conveyor belt system 320 and advise when the check is complete. Indicator lights 570, when flashing, show that checking is proceeding. When checking is complete, the indicator lights 570 will glow steady. Checking may, at present as visual confirmation of isolation is required, involve patrolling of the remote isolation stations 212 and 214 correspondent with conveyor belt system 320 to confirm permit isolation has occurred and that personal locks have been applied at each. At a later stage, such checking may be legally possible using the plant control system 260 alone. Checking may also require that keys for the locks have been returned to the permit room or CCR. As described above, the panel 1100 for the configurable isolation station, that being located at the permit room or CCR, has key. Keys correspondent with keys used at remote isolation stations 212 and 214 may require to be used to confirm isolation at the permit room.

Panel 600 of the remote isolation station (FIG. 15) has a human machine interface (HMI), with a touch screen 1265 (though less fragile buttons, switches and other input devices may be used), for entering commands including issuing isolation requests (though a dedicated, less fragile request button 440 is provided for this purpose also) and other commands. Information can also be presented on screen 1265. Panel 1100 also includes indicator lights in block 420 showing whether or not a remote isolation station, correspondent with one of the conveyor belt systems 20 or 320, is available for isolation. Conveyor belt 320 is selected as an example so the remote isolation station of interest is 212 or 214. Block 420 indicator lights may also indicate if a conveyor belt system 320 In this case) is under the exclusive control of the configurable isolation station 327 or the grand master controller 450 of plant control system 260.

Block 430 indicates whether each phase of a three phase motor for driving conveyor belt 321 is energised or not. Permit isolation requires all three phases to be de-energised and indicator lights L1, L2 and L3 will each be in an off state when the conveyor belt system 320 is isolated.

An operator at a remote or field isolation station, whether this be 212 or 214, may request isolation by pressing button 440, following the selection of conveyor belt system 320 for isolation. When the request is approved, “request authorized” indicator light block 450 illuminates steady green. As the request is pending, the indicator light block 450 may flash intermittently. If the request is not authorised, the indicator light block 450 illuminates steady red.

Following authorization by plant control system 260 and grand master controller 450, checking of the correctness of selection for the conveyor belt system 320 for isolation is conducted. Indicator lights 460 show that checking for correctness of isolation is proceeding (perhaps by these lights flashing). Checking may involve patrolling of the remote isolation stations correspondent with conveyor belt system 320 to confirm isolation has occurred and that personal locks have been applied at each. Checking may also require that keys for the locks have been returned to the permit room or CCR. As described above, the panel 1100 for at least one configurable isolation station 327, that being located at the permit room or CCR, has key locks and it may be mandated that the keys correspondent with a remote isolation station to be used to confirm isolation at the permit room.

Following checking, isolation switch 490 is then operable and the operator may lock the conveyor belt system 320 out at the remote isolation station 212 or 214 by operating the isolation switch 490. Following this operation of isolation switch 490, conveyor belt system 320 is isolated and indication of this state is displayed at panels 600 at the dedicated remote or field installation stations 212 and 214 showing that local isolation is “not available” Indication of isolation is also provided on CCR panel 1100.

The operator then presses button 480, in a final step of the isolation procedure, to implement a manual try start. An indication is provided at interface 1265, that is an indication of no power to conveyor belt drive motor, to show when the try start test is passed. Following successful conclusion of the isolation and checking steps, indicator light block 470 illuminates green to confirm isolation Is complete. If isolation is not complete, light block 470 illuminates red.

The operator may not need to do anything at remote isolation station 212 or 214. In such case, isolation procedure may be implemented from the CCR as above described. In that case, panel 600 provides indication of isolation procedure status as implemented by the CRO 42. The “not available” indicator light in block 420 is appropriately illuminated.

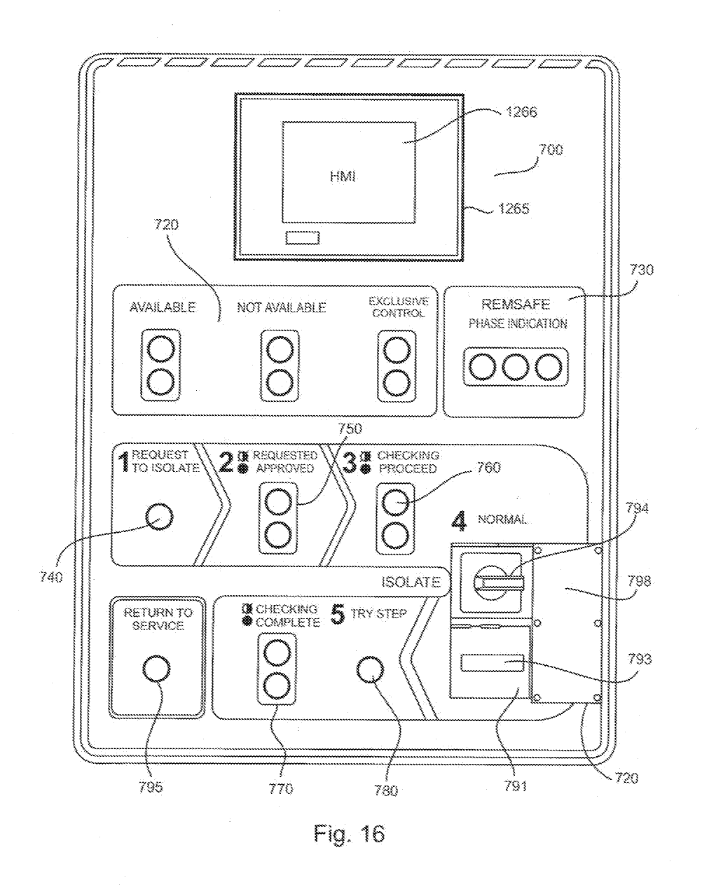

An alternative, but conceptually similar remote panel to remote panel 600 is remote panel 700 shown in FIG. 16. Panel 700 includes:
the human machine interface (HMI) 1265 with touch screen 1266 for entering commands and presenting information;
indicator lights in block 720 showing whether or not the remote isolation station is available for isolation; as well as whether a conveyor belt system, here conveyor belt system 320 is under exclusive control of CIS or grand master controller 450;
block 730 for indicating whether each phase of three phase motor for driving conveyor belt 321 is energised or not;
request isolation button 740 which is pressed by an operator to request isolation and “request approved” status indicator lights 750 which illuminates to provide status information in the same way as indicator light 450;
indicator light block 760 for showing, as with indicator light block 460, that grand master controller 450 is checking correctness of selection of conveyor belt 320 for isolation.
Indicator light block 770 for showing, as with light block, whether or not isolation is complete.

Panel 700 includes advantageous additional features including a return to service button 795 and an alternative configuration of isolation switch 720 which prevents regulatory isolation by locking with an operator's padlock until the isolation procedure, including a try start step “5” as requested by pressing button 780, is completed by the operator. To this end, isolation switch 720 is designed with a flap 791, as described below, to avoid providing an operator with any aperture, on which to apply a padlock, until try start is completed.

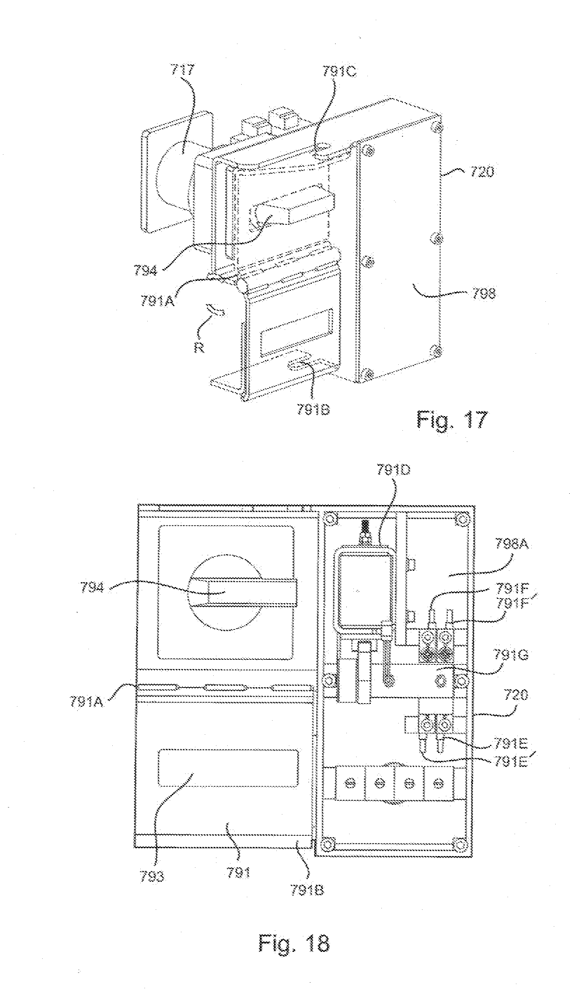

FIGS. 16 to 18 show isolation switch 720 in a “resting state” with the flap 791 and slot 793 (for accommodating isolation switch actuator 794 in isolated position) open and held captive through a magnetic interlock enabled by a solenoid 791D included within switch box 798A having cover 798 (held in place by secure fixing means).

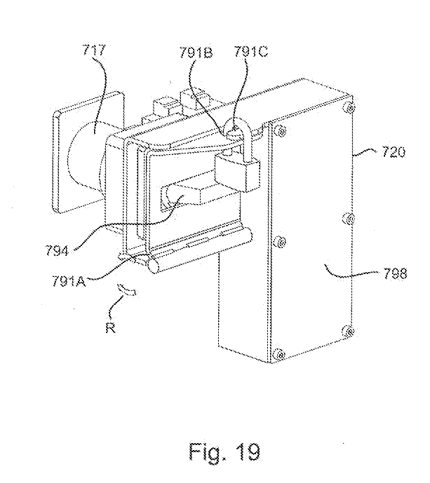

Isolation switch 720 includes, at top a slot 791C—which would not typically accommodate a locked padlock—and, on the flap 791, a slot 791B which would likewise not typically accommodate a locked padlock. However, flap 791 is releasable by solenoid 791D to rotate, as schematically indicated by arrows R, upward in anti-clockwise direction to cover the upper right portion of the isolation switch 720 to a locking position as shown in FIG. 19. When this occurs, slots 791B and 791C co-operate to form an aperture through which a padlock can be securely accommodated.

Flap 791 is only released to rotate upward to the locking position, when plant control system 260—and more particularly grand master controller 450—permits. This requires the isolation protocol, including the try start step “5” to be properly completed by the operator. Until that point, flap 791 is held captive in a resting position.

Flap 791 is connected to the rest of isolation switch 720 by a shaft 791A and driver shaft 791G. Solenoid 791D locks the shafts 791A and 791G in resting position with flap 791 unable to be rotated pending completion of a correct isolation procedure. This resting position is intended to be sensed by a set of proximity sensors 791E. 791E′ located below driver shaft 791G.

Grand master controller 450 releases the driver shaft 791G, and so shaft 791A, on completion of correct isolation procedure. Flap 791 may then be rotated anti-clockwise and upward to a position enabling lock out with the padlock as shown in FIG. 19. The locked position of flap 791 is intended to be sensed by a set of proximity sensors 791F, 791F′ located above driver shaft 791G.

The sets of proximity sensors 791E, 791E′; and 791F, 791F′ may be Hall Effect sensors which sense “resting” and “locked out” position of spaced magnetic implants within the driver shaft 791G for shaft 791A. So, plant control system 260 can identify the position of shafts 791A, 791G and the state of isolation switch 720. Proximity sensors 791E, 791E′; and 791F, 791F′ are provided in duplicate to ensure a high safety rating. So, if one proximity sensor, e.g. sensor 791E, fails, its duplicate sensor 791E′ remains operative. If any member of the sets of sensors 791E, 791E′; and 791F, 791F′ fail, grand master controller 450 places the isolation switch 720 in a “fail safe” state.

The proximity sensors 791E, 791E′; 791F, 791F′ also assist in preventing tampering or incorrect application of a padlock. For example, assuming an operator successfully attempted to place a padlock through slot 793 (though this should be prevented through the solenoid lock leaving insufficient room), the proximity sensors 791E, 791E′; 791F, 791F′ may be used to detect fouling through an incorrect positioning of flap 791. That is, flap 791 has only two permissible states, resting and locked out, which correspond with particular positions of driver shaft 791G (and so shaft 791A). Any mis-alignment can be detected and an error state, preventing isolation—or de-isolation—implemented by plant control system 260.

On correct de-isolation, flap 791 may be rotated clockwise back into the resting position to again be held captive through operation of solenoid 791D.

Panel 700 also includes a “return to service” button 795 at the bottom left. The object is to enable return to service following the de-isolation procedure similar to that described with reference to FIG. 10. If button 795 is pressed, plant control system 260 checks whether return to service is acceptable, for example identifying that conveyor belt system 320 has been de-isolated. Comparison with other permissives for return to service may also be made. If return to service is approved, conveyor belt system 320 is returned to service by grand master controller 450 of plant control system 260.

While the above description focuses on conveyor belt system 320, it is to be understood that conveyor belt system 20 is subjected to the same isolation procedures in preparation for maintenance works to be done on the conveyor belt systems. In addition, the assumption—for ease of illustration—that each step in the procedure has been successively passed is not exhaustive. The remote isolation system 410 of this embodiment of the invention allows for corrective action if any step of the procedure is not successfully passed. Such corrective action can include shutdown of the isolation procedure and requirement to recommence the selecting step as described above.

Remote isolation system 410 allows isolation of plant equipment items in a safe, time and cost effective manner in comparison with current methodology.

The remote isolation systems 10 and 410 are stand-alone systems, with a human-machine interface 51 and communications connection to the existing DCS or SCADA plant control systems. The resulting communications system transmits and receives data like:
Isolation requests and authorization.
Other plant control requests and authorization where necessary.
Remote isolation stations hardware status.
Remote isolation stations operational status.
Isolation status.
Communications fieldbus status and alarms.
General alarms
Activities log data
   , tasks extending to operational functions beyond isolation of equipment.

The HMI performs no conveyor control, acting purely for indication and monitoring of system 410. The existing plant DCS or SCADA system controls the conveyor belt systems 20 and 320 and will authorize the activation of a remote isolation. The CCR can therefore access and monitor all system data and so the system.

The remote isolation systems 10 and 410 meet the following general requirements:
Programmable Electronic System (PES) technology is used for the systems logic solver. The selected system is intended to be certified by a competent body, such as TUV, required to accommodate the most stringent protection category implemented in the system. The remote isolation system is designed to meet a SIL 3 rating.
The system master controllers, 50, 250, 350, 450 are located in an equipment room (not shown) and housed in a suitable enclosure.
The remote isolation stations 12, 14, 212, 214 are located in the field and housed in suitable weather-proof enclosures. Componentry is selected to cope with extreme temperatures, either heat or cold, if applicable.
Communications between the master controller and the DCS or SCADA is via Modbus TCP/IP protocol other protocols may be implemented if required
Communications between the master controller 50 and remote stations 12, 14, is via safety rated communications protocol software, for example: InterSafe™ or PROFIsafe™. Safety rated software, which includes protection from unauthorised modification, is highly important for use in the remote isolation system. The software packages are TUV certified up to at least SIL 3. This will ensure the communications links 11, 13, 155, 57 and so on are monitored and diagnostic tools are available for fault control and rectification.
Remote isolation system 10 also incorporates a manual lock out system.
All functions are designed such that movement of the final element to the isolation position will be performed by removing power from the element (i.e. de-energize to trip). Where this is not possible such as with shunt trips, suitably certified line-monitored output modules would be used.

Remote isolation systems 10 and 410 are designed to comply with mining regulations and applicable standards, as in force on 21 Apr. 2011, including Australian Standard AS 1755-2000 “Conveyors-safety requirements”, AS 61508-1999 (ASIEC/EN 61508-1998) “Functional Safety of electrical/electronic safety-related systems”, IEC/EN 61511-2004 (IEC/EN 61511-2003) “Functional Safety-Safety instrumented systems for the process industry sector”, IEC/EN 62061-2005 “Safety Machinery—Functional Safety of safety-related electrical, electronic and programmable electronic systems” and IEC/EN 61024-2007 “Machine Safety”, relevant portions of which are hereby incorporated herein by reference. It will be understood that applicable standards may be modified over time and the currently applicable standards are also incorporated herein by reference. The remote isolation system is certifiable to the SIL 3 level of safety by appropriate use of safety rated hardware and software components as above described. However, to maintain such a safety level, the isolation system requires regular monitoring to ensure that SIL rating does not track back below SIL 2 or lower which could occur over a period of months. It is anticipated, following a time integrity frequency (“TIF”) test, that 3 to 6 monthly servicing of the remote isolation system would be required to maintain the SIL 3 rating. Servicing would involve standard function testing and physical testing of system components.

Although the above description has been directed to electrically powered conveyor belt systems, the invention is not limited to conveyor belt systems or to electrically powered systems, but is equally applicable to other equipment and energy sources, such as for example, pneumatically powered robotic systems wherein an uncontrolled motion of a robotic arm may cause a hazard to maintenance personnel. In such case, the remote isolation system of the current invention would provide a system and apparatus to confirm that the pneumatic supply system was properly isolated from the robotic arm.

Other modifications and variations of the remote isolation system, method and apparatus of the invention may be apparent to skilled readers of this disclosure. Such modifications and variations are deemed within the scope of the present invention.

1. A remote isolation system for a plant comprising:
a plurality of plant equipment items; and
a control system in communication with said plurality of equipment items for enabling isolation, from an energy source, of said equipment items wherein said control system includes selecting means for selecting a set of equipment items to be isolated from said plurality of equipment items; and means to command isolation of equipment items in said selected set of equipment items following approval by said control system

2. An isolation system as claimed in claim 1 wherein said control system includes, or generates, configurable or virtual isolation station(s) for isolating said selected set of equipment items.

3. An isolation system as claimed in claim 2 wherein said configurable isolation station(s) are located remotely from said selected set of equipment items though in communication with said set.

4. An isolation system as claimed in claim 1 wherein a configurable isolation station isolates said selected set of equipment items independently of operation of any physical remote isolation station correspondent with said selected set of equipment items.

5. An isolation system as claimed in claim 1 wherein said selecting means includes a human machine interface (HMI) for selecting said set of equipment items for isolation.

6. An isolation system as claimed in claim 5 wherein said HMI includes a graphic user interface.

7. An isolation system as claimed in claim 1 wherein said plant control system performs approval and checking steps to ensure that isolation for said selected set of equipment items is consistent with a current set of permissives.

8. An isolation system as claimed in claim 7 wherein, if there is inconsistency between selection of equipment items for isolation and need for isolation, the selected equipment items are deleted by said control system from a list of equipment items for isolation.

9. An isolation system as claimed in claim 1 comprising remote isolation station(s) corresponding with plant equipment item(s), said remote isolation station(s) being in communication with said control system for granting approval of isolation of corresponding plant equipment item(s) from an energy source on permissible request

10. An isolation system as claimed in claim 1 including first circuit interrupter(s) which are in series connection with a primary stop/start switch for each equipment item to be isolated in said selected set of equipment items to be isolated, said first circuit interrupter(s) being controlled to the off state once isolation approval has been granted by the control system.

11. An isolation system as claimed in claim 10 including second circuit interrupter(s) in an energy supply line from an energy source for each equipment item to be isolated, said second circuit interrupter(s) being under the control of said control system and being placed in the off state once isolation approval has been granted by the control system.

12. An isolation system as claimed in claim 1 enabling an automated or virtual try start once a selected equipment item is isolated.

13. An isolation system as claimed in claim 12 allowing an operator to request a manual try start.

14. An isolation system as claimed in claim 9 wherein said control system includes means to over-ride approved isolation in certain exceptional circumstances.

15. An isolation system as claimed in claim 14 wherein exceptional circumstances include error in the control system.

16. An isolation system as claimed in claim 1 including a warning system alerting personnel to imminent isolation or deisolation.

17. An isolation system as claimed in claim 16 wherein said warning system is located at plant sub-station(s) corresponding with the selected equipment items to be isolated.

18. An isolation system as claimed in claim 1 wherein said control system conducts a stored energy test following an isolation request to ensure stored energy of equipment is safely released prior to isolation.
